(19) United States
(12) Patent Application Publication
(10) Pub. No.: US 2015/0019288 A1
(43) Pub. Date: Jan. 15, 2015

(54) System and Method to Increase Energy Efficient Behavior Changes, Measure Adoption and Utility Rebate Redemption

(71) Applicant: Suzanne Crofts Shelton, Knoxville, TN (US)

(72) Inventor: Suzanne Crofts Shelton, Knoxville, TN (US)

(21) Appl. No.: 13/940,183

(22) Filed: Jul. 11, 2013

(51) Int. Cl. G06Q 30/02

(52) U.S. Cl. CPC G06Q 30/0234
USPC 705/7.31; 705/14.34

(57) ABSTRACT

The present invention relates generally to a system and method to modulate rebate redemption using prior consumer practices to build action lists to increase rebate redemption rates. The rebate redemption program is embodied in a web-based computer program product for execution on an instruction processing system, made of a tangible storage medium readable by the instruction processing system and storing instructions for execution by the instruction processing system for performing, the method including the steps of filtering a plurality of data responses by program participants to define a plurality of program participating populations and providing each set of program participant populations with a rebate redemption plan and receiving rebate redemption forms, based on an action list provided to each group of program participants, wherein the program participating populations and rebate redemption plans are derived from surveying utility customers and the segmentation and predictive modeling system.

### CROSS-REFERENCE TO RELATED APPLICATIONS

This Application claims the benefit of U.S. Provisional Application 61/672,889 filed on Jul. 18, 2012.

### STATEMENT REGARDING FEDERALLY-SPONSORED RESEARCH OR DEVELOPMENT

Not Applicable.

### BACKGROUND OF THE INVENTION

1. Field of Invention

The present invention relates generally to a system and method to increase consumer engagement in energy efficiency and rebate redemption using techniques including predictive modeling, and more specifically, to providing enhanced rebate redemption via computer for energy-related rebate programs.

2. Description of the Related Art

In this age of ever-increasing energy consumption, incentives to encourage energy efficiency, energy use reduction and energy cost reduction are all important aspects of modern society. Various efforts to create consumer incentives towards energy efficiency have been implemented over time, including, inter alia, identifying household appliances with energy usage rating information, identifying insulation by a standard thermal resistance (“R”) value, etc. Further, often manufacturers and utility companies offer rebates as an incentive, to increase sales, encourage consumer savings, and enhance customer satisfaction.

From the manufacturer's or utility company's perspective, the rebate rubric is superior to the notion of overall lower pricing because rebate programs require the consumer to proactively complete whatever steps the manufacturer requires prior to receiving the rebate; many consumers who qualify for a rebate never complete the rebate request process, thus “breakage” occurs and the manufacturer retains the uncollected rebate monies. Conversely, from the consumer's perspective, rebate programs can seem tedious and cumbersome, particularly since traditional rebate programs have included mail-in rebates requiring paper receipts or proof of purchase.

With the introduction of the world wide web, many rebate programs are now available to consumers via computer. Such computer based rebate programs not only may lower costs for the manufacturer or utility provider, but also may increase the number of consumers who participate in the rebate program.

Governments and municipalities sometimes mandate utility companies provide rebate programs to customers in attempts to both lower the overall usage of energy by their constituent consumers and lower energy costs to their constituent consumers. Often, these government-mandated rebate programs feature monetary reward programs to utility companies in order to provide incentives to the utility companies to maximize customer participation in a utility rebate program. The higher the customer participation rate, the larger the monetary reward received by the utility provider. The reward programs to utilities typically include a requirement for measurable performance metrics in order to verify the number of utility customers who have participated in a utility rebate program. Thus, to maximize the utility's monetary reward payment from the government, the utility company has a need for accelerated, enhanced customer participation in a utility rebate program. In addition, the utility has a need for accelerated, enhanced customer engagement, so that each customer maximizes rebate potential by participating in more than one rebate activity. Further, the utility has need of a means of accurately measuring customer participation in such a program.

### SUMMARY OF THE INVENTION

Example embodiments of the present general inventive concept provide a method of optimizing delivery of rebate redemption to utility companies. This rebate redemption program is embodied in a web-based computer program product for execution on an instruction processing system. In some embodiments, this instruction processing system can be comprised of a tangible storage medium readable by the instruction processing system for performing the method of the present general inventive concept. An exemplary embodiment of the present general inventive concept method includes the steps of filtering a plurality of data responses by program participants to define a plurality of program participating populations and providing each set of program participant populations with a rebate redemption plan and rebate redemption form, based upon an action list provided to each group of program participants and receiving the form by the utility.

In at least one embodiment, a software engine is coded based on prior utility customer response data, such that specific content is served online and via email for each utility customer who enters information in response to a query. In other embodiments, predictive modeling techniques are used to enhance the fit of the action list(s) to further increase the rebate redemption rates by the utility customer.

These and other aspects, features and advantages of the invention will be understood with reference to the detailed description herein, and will be realized by means of the various elements and combinations particularly pointed out in the appended claims. Additional features and embodiments of the present general inventive concept will be set forth in part in the description which follows and, in part, will be obvious from the description, or may be learned by practice of the present general inventive concept. It is to be understood that both the foregoing general description and the following detailed description of the invention are exemplary and explanatory of preferred embodiments of the present general inventive concept, and are not restrictive of the invention as claimed.

### BRIEF DESCRIPTION OF THE DRAWINGS

The above-mentioned and additional features of the invention will become more clearly understood from the following detailed description of the invention read together with the drawings in which:

FIG. 1 is a diagram illustrating a first embodiment of the present general inventive concept;

FIG. 2 is a diagram illustrating a second embodiment of the present general inventive concept;

FIG. 3 is a flow chart for an exemplary embodiment of the present general inventive concept.

### DETAILED DESCRIPTION OF THE INVENTION

The following detailed description may recite various descriptive terms such as horizontal, vertical, top, bottom, upward, downward, left, right, etc., when referring to the exemplary figures, but the present general inventive concept is not limited to any such terms or physical orientations. Such terms are used for convenience of description only, and could be reversed, modified, or interchanged without departing from the broader scope and spirit of the present general inventive concept.

The present general inventive concept may be understood more readily by reference to the following detailed description of the present general inventive concept. It is to be understood that this present general inventive concept is not limited to the specific devices, methods, conditions or parameters described herein, and that the terminology used herein is for the purpose of describing particular embodiments by way of example only and is not intended to be limiting of the claimed invention. Also, as used in the specification including the appended claims, the singular forms, “a,” “an,” and “the” include the plural, and reference to a particular numerical value includes at least that particular value, unless the context clearly dictates otherwise. Ranges may be expressed herein as from “about” or approximately” one particular value and/or to “about” approximately” another particular value. When such a range is expressed, other embodiments can include from one particular value and/or to the other particular value. Similarly, when values are expressed as approximations, by use of the antecedent “about,” it will be understood that the particular value can form another embodiment.

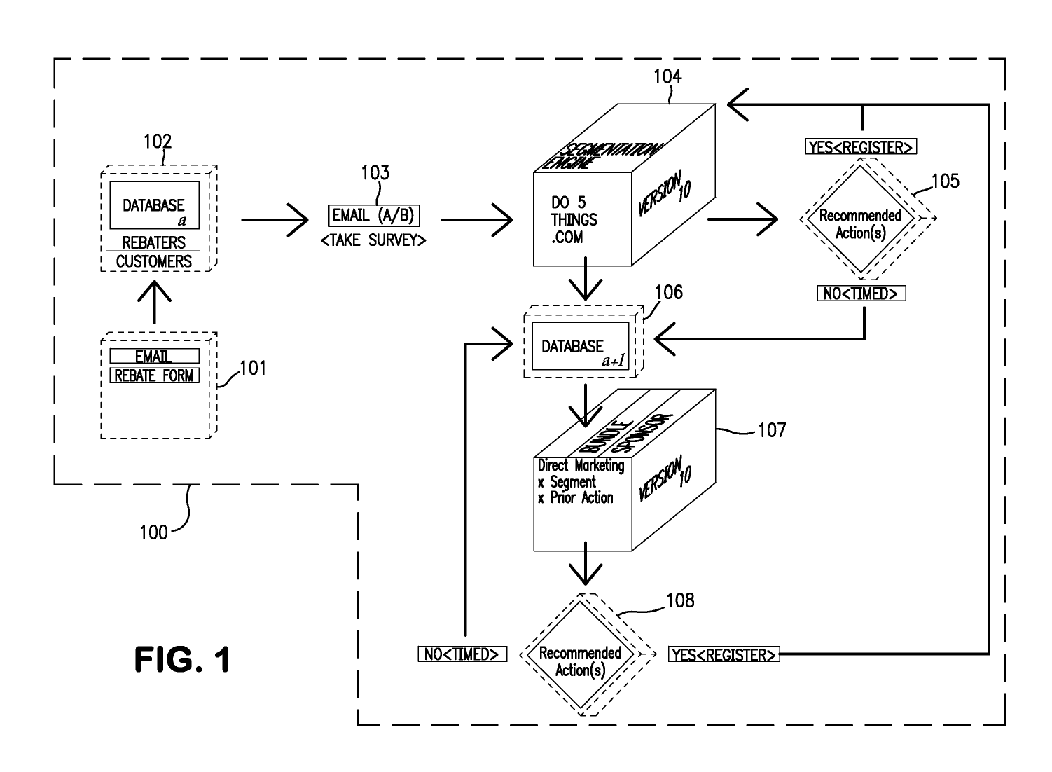

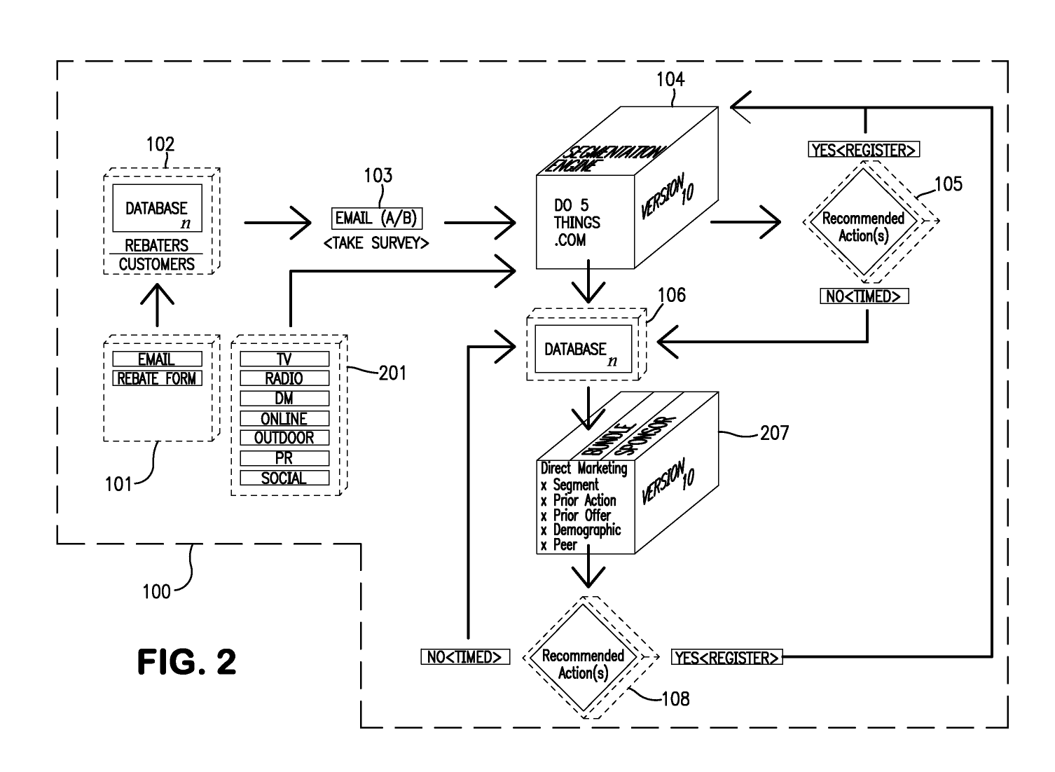

In FIGS. 1 and 2, it will be appreciated that computer system 100 can be controlled by operating system software which includes a file management system, such as, for one example, a disk operating system, which can be part of the operating system software. The file management system can be stored in a non-volatile storage device and may be configured to cause a processor to execute the various functions required by the operating system to input and output data and to store data in memory and on the non-volatile storage device. The architecture of the system can be either Cloud or client-server based. Cloud computing refers to the use and access of multiple server-based computational resources via a digital network (WAN, Internet connection using the World Wide Web, etc.). Cloud users may access the server resources using a computer, netbook, pad computer, smart phone, or other device. In cloud computing, applications are provided and managed by the cloud server and data can also be stored remotely in the cloud configuration.

As illustrated in FIG. 1, the computer system 100 receives electronic data from an electronic source, such as, for one example, an email or electronic rebate form 101. The electronic data is stored in database 102. A utility customer is asked to take a survey 103. The survey 103 results are transmitted to a segmentation engine 104. The segmentation engine 104 allows the process of segmenting consumers based on messaging preferences and likelihood to participate in specific rebate programs.

The segmentation engine 104 sorts the utility customers to provide recommended action list(s) 105 that are designed to elicit participation from various types of utility customers, such participation including registration into the program website for further instructions. A utility customer can be directed to return to the program website and to redeem a rebate for an energy program. The rebate can be redeemed by uploading the document to the program website.

If the utility customer does not register with the website, then that data can be transmitted to database 106. The utility customer can be contacted electronically and directed to the program URL to register with the website. If they do not register, then that data can be directed to database 106 for the same follow up to elicit compliance.

FIG. 2 shows a flow diagram of the interrelated components of the present general inventive concept with an enhanced marketing component 201. The computer system 100 receives electronic data 102 from an electronic source such as, for example, an email or an electronic rebate form 101. The electronic data can be stored in database 102. The utility customer is asked to take a survey 103. This survey 103 result is transmitted to a segmentation engine 104. The segmentation engine 104 allows the process of segmenting respondent customers and identifying the number of recipients in each segment to provide recommended action list(s) 105 that are designed to elicit participation from various types of utility customers, such participation including registration into the program website for further instructions. Optional, additional mass marketing campaign 201 can drive utility customers to the website so they can answer a query and receive a specific action plan(s).

The segmentation engine 104 sorts customers to provide recommended action list(s) 105 that are designed to elicit participation from various types of utility customers, such participation including registration into the program website for further instructions. A utility customer can be directed to return to the program website and to redeem a rebate for an energy program. The rebate is redeemed by uploading the document to the program website. In some embodiments, if the utility customer does not register with the website, then that data can be transmitted to database 106. Software engine 207 can then review direct marketing, prior action data, prior offers, demographics and peer data to formulate recommended action list(s) 108. The action list(s) 108 can be sent to the utility customers. The action list(s) 108 can be specific to each set of customers and the rebate redemption plan in the action list(s) 108 can be designed to increase the utility customer's participation in a rebate redemption program. A utility customer can be directed to register at the program URL. If the utility customer does not register then that data is directed to database 106 for further follow up as desired.

Predictive modeling can be applied to potentially increase redemption rates. In one exemplary embodiment, the predictive modeling can be achieved by computer implemented software system for selection of content transformation rules for application to unstructured text content in customer accounts. In this and similar examples, each customer account has a structure content record of data associated with a program participant; unstructured text content derived from an interaction with the program participant; and a predicted outcome of an event related to the program participant; an index of source tokens derived from the unstructured text content of the program accounts, each source token associated with at least one of the structured content records; a database of content transformation rules, each transformation rule adapted to produce a token in response to a source token; a predictive model, adapted to generate the predicted outcomes of events related to the program participants using the structured content records and tokens derived from the unstructured text content using the content transformation rules; and a rules selection process, adapted to apply selected transformation rules to the index to produce tokens from the source tokens, and identify transformation rules that improve the accuracy of the predictive model.

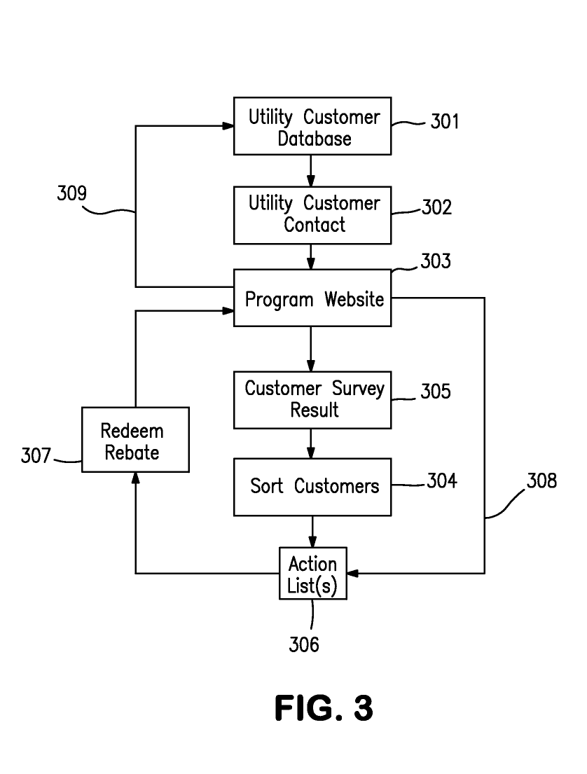

Now referring to FIG. 3, a utility customer database 301 is constructed to include contact information for at least one utility customer. In some embodiments, a plurality of utility customers and appropriately corresponding contact information is included in utility customer database 301. Utility customer contact 302 is made and the utility customer can be directed to go to the program website 303 and participate in a survey. The survey results 305 are sorted 304 by customer answers to the query. This generates at least one action list 306 which can be sent to the utility customer. In some embodiments, a plurality of action list(s) 306 is generated. In some embodiments, the action list 306 or plurality of action list(s) 306 include at least one rebate offer. In some embodiments, the action list 306 or plurality of action list(s) 306 include a plurality of rebate offers. The utility customer can complete a rebate redemption form 307 via, in some embodiments, the program website 303. Upon submitting a rebate redemption form 307 to program website 303 for redemption, program website 303 can update 309 database 301 to reflect the redeemed rebate 307. Additionally and separately, program website 303 can update 308 action list(s) 306 to reflect the completed action, i.e., the redeemed rebate, and, optionally and separately, segmentation engine 104 (see FIG. 1) contained within program website 303 can modify action list(s) 306 to add additional energy-saving rebate offers to the action list(s) 306.

In some embodiments, based upon the updated information provided by redeemed rebate 307 to program website 303 and the update 309 from program website 303 to utility customer database 301, utility customer database 301 can generate a subsequent utility customer contact 302; the utility customer can respond to utility customer contact 302 by revisiting program website 303 and receiving the updated 308 action list(s) 306. This sequence of events can be repeated until the utility customer has redeemed all rebates provided on the action list(s) 306.

With each update 309 to utility customer database 301, the utility company receives a measurable response on rebate activities. By harvesting this response data from the utility's database 301, the utility can provide the requisite performance metrics of the government monetary rewards program by accurately measuring accelerated, enhanced customer participation in a utility rebate program(s) and accelerated, enhanced customer engagement, where each participating customer has potentially maximized their rebate opportunities via participating in more than one rebate activity or program.

In some embodiments, optionally program website 303 can periodically update 309 utility customer database 301 to note customers who have not yet participated in the initial survey; utility customer database 301 can be instructed to provide periodic, ongoing utility customer contact 302 in attempts to engage the noncompliant customer. Similarly, and optionally, in some embodiments, as program website 303 updates 309 utility customer database 301 with positive rebate redemption information, utility customer database 301 can be instructed to provide periodic, ongoing utility customer contact 302 in attempts to urge a participant customer to redeem other rebates 307. In some embodiments, utility customers are sorted (see FIG. 3, ref. 304) into at least two groups, each group resulting in action list(s) 306 that contain actions specifically targeted to the group, to maximize potential engagement by that discreet group in the rebate redemption process; in certain exemplary embodiments, the utility customers are sorted into four discreet groups, based upon their survey responses.

While the present general inventive concept has been illustrated by description of some embodiments, and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

It is also noted that numerous variations, modifications, and additional embodiments are possible, and, accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Accordingly, while the present general inventive concept has been illustrated by description of several embodiments, it is not the intention of the applicant to restrict or in any way limit the scope of the inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings.

What is claimed is:

1. A system for increasing consumer adoption of energy efficient measures and behaviors and utility rebate redemption for such by at least one utility customer comprising:
a behavior modification and rebate redemption program embodied in a computer program product for execution on an instruction processing system, said instruction processing system including a tangible storage medium readable by said instruction processing system, and, further, said tangible storage medium storing instructions for execution by said instruction processing system for performing said rebate redemption program.

2. A system for increasing consumer adoption of energy efficient measures and behaviors and utility rebate redemption for such by at least one utility customer comprising:
a rebate redemption program embodied in a computer program product for execution on an instruction processing system, said instruction processing system including a tangible storage medium readable by said instruction processing system, and, further, said tangible storage medium storing instructions for execution by said instruction processing system for performing said rebate redemption program, said rebate redemption program comprising an operable utility customer database, said operable utility customer database defined to include utility customer contact information whereby at least one utility customer may be identified and contacted, a utility customer survey, said utility customer survey requiring at least one response relative to said utility customer's utility usage, and a segmentation engine for categorizing said at least one response, said segmentation engine sorting said at least one response to create discreet and identifiable utility customer behavior categories, and thereby generating at least one action list per at least one utility customer, said action list containing at least one utility rebate offer to induce said at least one utility customer to redeem said at least one utility rebate.

3. A system for increasing consumer adoption of energy efficient measures and behaviors and utility rebate redemption for such by at least one utility customer comprising:
a rebate redemption program embodied in a computer program product for execution on an instruction processing system, said instruction processing system including a tangible storage medium readable by said instruction processing system, and, further, said tangible storage medium storing instructions for execution by said instruction processing system for performing said rebate redemption program, said rebate redemption program comprising an operable utility customer database, said operable utility customer database defined to include utility customer contact information whereby at least one utility customer may be identified and contacted, a utility customer survey, said utility customer survey requiring at least one response relative to said utility customer's utility usage, and a segmentation engine for categorizing said at least one response, said segmentation engine sorting said at least one response to create discreet and identifiable utility customer behavior categories, and thereby generating at least one action list per at least one utility customer, said action list containing at least one utility rebate offer to induce said at least one utility customer to redeem said at least one utility rebate; and an operable rebate redemption processing interface, said operable rebate redemption processing interface comprising providing an update to said operable utility customer database and to said segmentation engine to record said rebate redemption, such that said segmentation engine being thus updated next generates a correspondingly updated at least one action list and said database being thus updated next identifies and contacts said at least one utility customer, to encourage said at least one utility customer to revisit said rebate redemption program to obtain said updated at least one action list to induce said at least one utility customer to redeem said at least one utility rebate.

4. The system of claim 1, in which said system is available for use by said at least one utility customer via electronic means.

5. The system of claim 2, in which said system is available for use by said at least one utility customer via an electronic means.

6. The system of claim 3, in which said system is available for use by said at least one utility customer via an electronic means.

7. The system of claim 1, in which said system is available for use by said at least one utility customer via a digital means.

8. The system of claim 2, in which said system is available for use by said at least one utility customer via a digital means.

9. The system of claim 3, in which said system is available for use by said at least one utility customer via a digital means.

10. The system of claim 2, in which said operable utility customer database contains said utility customer contact information for a plurality of utility customers.

11. The system of claim 3, in which said operable utility customer database contains said utility customer contact information for a plurality of utility customers.

12. The system of claim 2, in which said at least one action list contains a plurality of utility rebate offers.

13. The system of claim 3, in which said at least one action list contains a plurality of utility rebate offers.

14. The system of claim 2, in which said at least one action list contains five utility rebate offers.

15. The system of claim 3, in which said at least one action list contains five utility rebate offers.

16. The system of claim 2, in which said segmentation engine generates a plurality of action lists.

17. The system of claim 3, in which said segmentation engine generates a plurality of action lists.

18. A method to increase utility customer's participation in a rebate redemption program embodied in a computer program product for execution on an instruction processing system, said instruction processing system including a tangible storage medium readable by said instruction processing system and, further, said storage medium storing instructions for execution by said instruction processing system for performing said method, said method comprising:
filtering a plurality of data responses provided by utility customers to define a plurality of program participant populations; and
providing each set of program participant populations with at least one rebate redemption action plan to provide the incentive for increased utility customer's participation in said rebate redemption program.

19. A method of optimizing delivery of rebate redemption to a utility, said rebate redemption being controlled by a rebate redemption program, said rebate redemption program including a tangible storage medium readable by said instruction processing system and, further, said storage medium storing instructions for execution by said instruction processing system for performing said method, said method comprising:
filtering a plurality of data responses provided by utility customers to define a plurality of program participant populations; and
providing each set of program participant populations with at least one rebate redemption action plan.

20. The method of claim 18, said method further comprising a predictive modeling component whereby each customer account has a structure content record of data associated with a customer participant, unstructured text content derived from an interaction with said customer participant, and a predicted outcome of an event related to said customer participant;
an index of source tokens derived from said unstructured text content of said program accounts, each source token associated with at least one of said structured content records;
a database of content transformation rules, each transformation rule adapted to produce a token in response to a source token;
a predictive model, adapted to generate the predicted outcomes of events related to said customer participant using said structured content records and tokens derived from said unstructured text content using said content transformation rules; and
a rules selection process, adapted to apply selected transformation rules to said index to produce tokens from said source tokens, and identify transformation rules that improve the accuracy of said predictive model.
